(19) United States
(12) Patent Application Publication
(10) Pub. No.: US 2025/0088132 A1
(43) Pub. Date: Mar. 13, 2025

(54) THIN-FILM-BASED OPTICAL STRUCTURES FOR THERMAL EMITTER APPLICATIONS

(71) Applicant: The Regents of the University of California, Oakland, CA (US)

(72) Inventors: Jeremy N. Munday, Davis, CA (US); Marina S. Leite, Davis, CA (US)

(73) Assignee: The Regents of the University of California, Oakland, CA (US)

(21) Appl. No.: 18/416,673

(22) PCT Filed: Jul. 29, 2022
(86) PCT No.: PCT/US2022/038894

§ 371 Date: Jan. 18, 2024

Related U.S. Application Data
(60) Provisional application No. 63/227,422, filed on Jul. 30, 2021.

(51) Int. Cl. H02S 10/30; F24S 70/20

(52) U.S. Cl. CPC H02S 10/30; F24S 70/20

(57) ABSTRACT

A thin-film-coating/substrate two-layer thermal absorber/emitter structure is configured with controllable emission properties at ultra-high operating temperatures. The proposed two-layer thermal absorber/emitter structure is composed of a substrate made of a first material, and a thin-film layer/coating made of a second material and disposed on the substrate. The single thin-film layer or coating provides control and tuning of the emission properties of the overall two-layer thermal absorber/emitter structure. Both materials selected for the absorber/emitter structure possess high melt points to withstand extreme temperature variations. The two-layer thermal absorber/emitter structure reduces the complexity and cost of fabrication and manufacture and the likelihood of thermal failure.

### CROSS-REFERENCE TO RELATED APPLICATION

This application claims the benefit of U.S. Provisional Patent Application Ser. No. 63/227,422, entitled “Thin Films for Optical Absorber/Emitter Thermophotovoltaics Structures,” Attorney Docket Number UC22-506-1PSP, filed on 30 Jul. 2021, the contents of which are incorporated by reference herein.

### BACKGROUND

### Field

The disclosed embodiments generally relate to the field of ultra-high temperature photonics. More specifically, the disclosed embodiments relate to an optical absorber/emitter structure capable of emitting at a tunable emission wavelength for use in thermophotovoltaic and other devices.

### Related Art

In the past two decades, tremendous technological advances have given rise to room temperature photonics where metallic and dielectric structures have allowed for nearly complete control of optical radiation using plasmonics and metamaterials. However, at extreme temperatures and/or under harsh environments relevant to many real-world applications, the existing photonic techniques cannot be fully utilized to design modern thermal emitters because there is a lack of knowledge about how materials (and specifically their optical properties) respond under these extreme conditions. Moreover, many of the emitter design concepts involving metamaterials are based on nanostructuring photonic materials into 2D or 3D arrays. However, forming nanostructures using photonic materials can be very challenging due to generally non-existent etching procedures for such materials. Furthermore, applications involving extreme conditions make it infeasible to use such nanostructures due to thermal and chemical stresses, and expansions that occur under such extreme conditions.

Hence, what is needed is a thermal emitter design for these extreme operating environments without the drawbacks of the existing techniques.

### SUMMARY

This disclosure provides a thin-film-coating/substrate two-layer thermal absorber/emitter structure configured with controllable emission properties at ultra-high operating temperatures. The thermal absorber/emitter structure is composed of a substrate made of a first material and a thin-film layer/coating made of a second material that is disposed on the substrate. Use of a single thin-film layer/coating provides control and tuning of the emission properties of the overall two-layer structure. Both materials selected for the absorber/emitter structure possess high melting points to withstand extreme temperature variations. Note that the simple two-layer design of the absorber/emitter structure reduces the likelihood of thermal failure the use of a single coating on the substrate makes it easier to choose thermally matched materials. Moreover, for the properly selected materials, the thin-film layer or coating can serve two functions: (1) as a protective barrier/interface; and (2) as the primary optical layer. Furthermore, the absorber/emitter structure can be easily scaled up for commercial applications.

A thin-film-coating/substrate two-layer thermal absorber/emitter structure provided herein can be tailored for ultra-high temperature photonics and systems. In addition, the structure allows for the control of the wavelength/bandwidth and directionality of thermal radiation throughout the visible and near-infrared (NIR) ranges, while operating at extreme temperatures of >1500° C. The absorber/emitter structure and systems using the structure as a selective emitter can circumvent many of the challenges faced by existing emitter designs and applications as a result of the single thin-film coating, which is more tolerant to thermal and chemical stresses and cracking, and does not require complex and time-consuming nano-fabrication processes.

Embodiments of the absorber/emitter structure allow for controlling and tuning a number of emission properties, such as the peak emission wavelength, emission bandwidth, and emission angle at ultra-high temperatures. The target operating temperature range is between 1500° C. and 2200° C. To configure the structure with such properties, we apply the concept of optical phase accumulation effects in the disclosed two-layer structure. This optical phenomenon is integrated with a wide selection of ultra-high temperature materials to gain arbitrary control of the emission spectrum of the resulting two-layer/material system. In addition to known materials (e.g., ternary nitrides and Y stabilized ZrO2), other materials such as novel alloys (e.g., quaternary nitrides using Ti, Ta, Zr, Hf, Mg, Ca, Sc, Y, and Al, transition metals oxides: Hf—Ta—O, and carbides: Ta—Hf—C) for the optical layer/coating can be developed and selected to enable further tuning of the emission properties.

This disclosure additionally provides applications of the thermal absorber/emitter structure in silicon thermophotovoltaics (TPV) systems as a selective emitter, and demonstrates that the proposed TPV systems outperform the current state-of-the art silicon TPV system in terms of heat-to-electricity efficiency by more than a factor of 4 by suppressing long wavelength emissions by 80%. The structure provides tunability of emission properties at temperatures above 1000° C. by way of making judicious material choices for each of the two layers, and by controlling the thicknesses of one (i.e., the thin-film layer) or both layers. The ability to tune thermal emission using materials that can operate at ultra-high temperatures (>1500° C.) using scalable, ultra-thin films will have significant impact on a wide-range of applications including TPV, aerospace heat shields, efficient turbine designs, nuclear materials, satellites, thermal cloaking, etc. However, use of the two layer thermal absorber/emitter structure is not limited to silicon TPV systems, but can be broadly applicable to many ultra-high temperature systems.

In one aspect, a thermal absorber/emitter is disclosed. This thermal absorber/emitter includes a substrate layer and a thin-film layer disposed over the substrate layer. The thin-film layer is used for controlling and tuning emission properties of thermal radiation emitted from the thermal absorber/emitter at an operating temperature exceeding 1500° C.

In some embodiments, the emission properties of the thermal radiation include an emission spectrum, wherein the emission spectrum of the thermal absorber/emitter is tunable by varying the thickness of the thin-film layer.

In some embodiments, the tunable emission properties include one or more of: (1) a peak emission wavelength of the thermal radiation; (2) a bandwidth of the thermal radiation; and (3) an emission angle of the thermal radiation.

In some embodiments, the thermal absorber/emitter operates in an environment featuring a temperature greater than 1500° C.

In some embodiments, the thin-film layer comprises a single layer no thicker than 1 μm.

In some embodiments, the substrate layer has a minimum thickness of 1 μm.

In some embodiments, the substrate layer is made of a first material and the thin-film layer is made of a second material, and the first material and the second material are different materials.

In some embodiments, the emission properties of the thermal absorber/emitter are tunable by selecting the second material from a plurality of materials having different optical properties.

In some embodiments, the first material and the second material have different optical properties.

In some embodiments, the first material and the second material are high melt-point materials for operating temperatures exceeding 1500° C.

In some embodiments, the first material and the second material are thermally matched materials at operating temperatures exceeding 1500° C.

In some embodiments, the second material is selected so that the thin-film layer functions as a protective barrier for the thermal absorber/emitter.

In some embodiments, at least one of the first material and the second material comprises one or more of the flowing refractory metals: Cr, Hf, Ir, Mo, Nb, Os, Re, Ru, Ta, Ti, and W.

In some embodiments, at least one of the first material and the second material comprises a carbide that includes one or more elements selected from the following group of elements: B, C. Si, Nb, Hf, Ta, Ti, V. W, and Zr.

In some embodiments, at least one of the first material and the second material comprises a metal nitride that includes a metal element selected from the following group of elements: Al, B. Sc. Hf, Nb, Ti, V, and Zr.

In some embodiments, at least one of the first material and the second material comprises a metal oxide that includes a metal element selected from the following group of elements: MgAl, Al, Bc, Ca, Cr, Mg. Sc. Dy, Gd, Hf, La, Lu, Nb, Sc, Ta, Ti, Y, and Zr.

In some embodiments, at least one of the first material and the second material comprises a silicide that includes a metal element selected from the following group of elements: Mo, Ta, and W.

In some embodiments, at least one of the first material and the second material comprises a boride that includes a metal element selected from the following group of elements: Hf, Nb, Ta, Ti, and Zr.

In another aspect, a silicon (Si) thermophotovoltaic (TPV) system is disclosed. This Si TPV system includes a selective absorber/emitter and a photovoltaic (PV) cell made of Si. The selective absorber/emitter further includes a substrate layer and a thin-film layer disposed over the substrate layer. Note that the thin-film layer is used for controlling and tuning emission properties of thermal radiation emitted from the selective absorber/emitter at a target operating of the Si TPV system.

In some embodiments, the emission properties of the thermal radiation include an emission spectrum, wherein the emission spectrum of the selective absorber/emitter is tunable by varying the thickness of the thin-film layer.

In some embodiments, the tunable emission properties include one or more of: (1) a peak emission wavelength of the thermal radiation; (2) a bandwidth of the thermal radiation; and (3) an emission angle of the thermal radiation.

In some embodiments, the substrate layer of the selective absorber/emitter is made of a first material and the thin-film layer of the selective absorber/emitter is made of a second material, and the first material and the second material are different materials.

In some embodiments, the emission properties of the selective absorber/emitter are tunable by selecting from a plurality of materials having different optical properties as the second material for the thin-film layer.

In some embodiments, the first material and the second material have different optical properties.

In some embodiments, the first material and the second material are high melt-point materials for operating temperatures exceeding 1500° C.

In some embodiments, the first material and the second material are thermally matched materials at operating temperatures exceeding 1500° C.

In some embodiments, the second material is selected so that the thin-film layer functions as a protective barrier for the selective absorber/emitter.

In yet another aspect, a system for designing a selective absorber/emitter is disclosed. During operation, the system begins by receiving a target emission spectrum corresponding to a target operating temperature. The system then selects a first material for forming a substrate of the selective absorber/emitter based on the target operating temperature. Next, the system selects a second material for forming a thin-film coating on the substrate to form the selective absorber/emitter. The system subsequently tunes a property of the thin-film coating to obtain a configuration of the selective absorber/emitter that gives rise to the target emission spectrum.

In some embodiments, the system selects the second material by selecting a material that is thermally matched with the first material at the target operating temperature.

In some embodiments, the system tunes the property of the thin-film coating to obtain the configuration by varying a thickness of the thin-film coating to obtain a plurality of configurations of the selective absorber/emitter. Next, the system determines a plurality of emission spectra corresponding to the plurality of configurations of the selective absorber/emitter at the target operating temperature. Next, the system identifies in the plurality of emission spectra, a first emission spectrum that matches the target emission spectrum. The system subsequently fixes the configuration of the selective absorber/emitter using the thickness of the thin-film coating corresponding to the first emission spectrum.

In some embodiments, the system determines a given emission spectrum in the plurality of emission spectra corresponding to a given configuration in the plurality of configurations by first determining an absorption spectrum corresponding to the given configuration at the target operating temperature. The system then determines the given emission spectrum from the determined absorption spectrum based on the principle of reciprocity.

In some embodiments, to obtain the configuration of the selective absorber/emitter, the system tunes the thickness of the thin-film coating to effectuate a shift of a peak emission wavelength of the selective absorber/emitter toward the peak emission wavelength of the target emission spectrum.

### BRIEF DESCRIPTION OF THE FIGURES

FIG. 1 shows a schematic representation of a thin-film-based thermal absorber/emitter structure configured with controllable emission properties at ultra-high operating temperatures in accordance with the disclosed embodiments.

FIG. 2 shows the concept of customizing optical properties by alloying two metals Ag and Au.

FIG. 3A shows a thermal-mismatch pixel map generated for an exemplary collection of candidate materials at a room temperature T=20° C. in accordance with the disclosed embodiments.

FIG. 3B shows another thermal-mismatch pixel map generated for the exemplary collection of candidate materials at a very high temperature T=1000° C. in accordance with the disclosed embodiments.

FIG. 3C shows yet another thermal-mismatch pixel map generated for the exemplary collection of candidate materials at an ultra-high temperature T=1800° C. in accordance with the disclosed embodiments.

FIG. 4A shows the isotropic blackbody emission generated by a bulk material.

FIG. 4B shows the controllable emission of a two-layer thermal absorber/emitter structure in accordance with the disclosed embodiments.

FIG. 5 shows the comparisons of an ideal blackbody emission spectrum at 2200° C. and tunable emission spectra generate by the absorber/emitter structure in accordance with the disclosed embodiments.

FIG. 6 presents a flowchart illustrating a process of designing a selective absorber/emitter having a tunable emission profile based on the disclosed two-layer absorber/emitter structure in accordance with the disclosed embodiments.

FIG. 7 illustrates an exemplary Si TPV system using a two-layer structure as the selective emitter in accordance with the disclosed embodiments.

FIG. 8 shows an exemplary modified emission spectrum of the exemplary Si TPV system shown in FIG. 7 resulting from tuning the thin-film coating 706, and the corresponding PV output power profile in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Terminology

Throughout this patent disclosure, the terms “thin-film layer” and “thin-film coating” are used interchangeably to refer to the single layer of optical material coated or otherwise disposed on a surface of the substrate of the disclosed absorber/emitter structure.

### Overview

A two-layer thermal absorber/emitter structure is provided that is configured with controllable emission properties at ultra-high operating temperatures. The thermal absorber/emitter structure is composed of a substrate made of a first material and a thin-film layer/coating made of a second material that is disposed on the substrate. The single thin-film layer/coating provides control and tuning of the emission properties of the overall two-layer absorber/emitter structure. Both materials selected for the absorber/emitter structure possess high melting points to withstand extreme temperature variations.

The simple two-layer design of the absorber/emitter structure reduces the likelihood of thermal failure due to the fact that having just one coating on the substrate makes it easier to choose thermally matched materials. Moreover, for the properly selected materials, the thin-film layer/coating can serve two functions: (1) as a protective barrier/interface; and (2) as the primary optical layer. Furthermore, the absorber/emitter structure can be easily scaled up for commercial applications.

A two-layer thermal absorber/emitter structure disclosed herein can be tailored for ultra-high temperature photonics and systems. The structure also allows for control of the wavelength/bandwidth and directionality of thermal radiation throughout the visible and near-infrared (NIR) ranges, while operating at extreme temperatures of >1500° C. The absorber/emitter structure and systems using the structure as selective emitters can circumvent many of the challenges faced by the existing emitter designs and applications as a result of using the single thin-film coating on the substrate, which are more tolerant to thermal and chemical stresses and cracking, and do not require complex and time-consuming nano-fabrication processes.

The absorber/emitter structure allows for controlling and tuning a number of emission properties, such as the peak emission wavelength, emission bandwidth, and emission angle at ultra-high temperatures. The target operating temperature range is between 1500° C. and 2200° C. To configure the absorber/emitter structure with such properties, we apply the concept of optical phase accumulation effects. This optical phenomenon is integrated with a wide selection of ultra-high temperature materials to gain arbitrary control of the emission spectrum of the resulting two-layer/material system. In addition to known materials (e.g., ternary nitrides and Y stabilized ZrO₂), other materials such as novel alloys (e.g., quaternary nitrides using Ti, Ta, Zr, Hf, Mg. Ca, Sc, Y, and Al, transition metals oxides: Hf—Ta-O, and carbides: Ta—Hf—C) for the optical layer/coating can be developed and selected to enable further tuning of the emission properties.

This disclosure additionally provides applications of the thermal absorber/emitter structure in silicon (Si) thermophotovoltaic (TPV) systems as a selective emitter, and demonstrates that the proposed Si TPV systems outperform the current state-of-the art Si TPV system in terms of heat-to-electricity efficiency by more than a factor of 4, by suppressing long wavelength emissions. The disclosed structure provides tunability of emission properties at temperatures above 1000° C. by ways of making judicious material choices for each of the two layers and by controlling the thickness of one (e.g., the thin-film layer) or both layers. The ability to tune thermal emission using materials that can operate at ultra-high temperatures (>1500° C.) using scalable, ultra-thin films will have a significant impact on a wide-range of applications including TPV, aerospace heat shields, efficient turbine designs, nuclear materials, satellites, thermal cloaking, etc. However, the applicability of the thermal absorber/emitter structure is not limited to Si TPV systems, but rather is broadly applicable to many ultra-high temperature systems.

### Controlling Emission Properties Using a Single Thin-Film Layer/Coating

Thin-film interference effects have been used for decades to control transmission and reflection of light off a surface. However, the thickness of these films is traditionally on the order of the wavelength of the incident light, and multiple layers are needed to achieve reasonable performance. Recently, it has been shown that ultra-thin films (which can be an order of magnitude thinner than the wavelength of the incident light) can function as perfect absorbers/emitters with tunable spectra. It has also been demonstrated that nearly 100% absorption (either with broadband or tunable narrowband) can be achieved throughout both the visible and the near-infrared (NIR) using ultra-thin films deposited on a variety of metals, metal alloys, low-index-of-refraction substrates, and semiconductors. In contrast, the disclosed designs of the thermal emitters with tunable emission spectra are based on using a single ultra-thin film layer/coating.

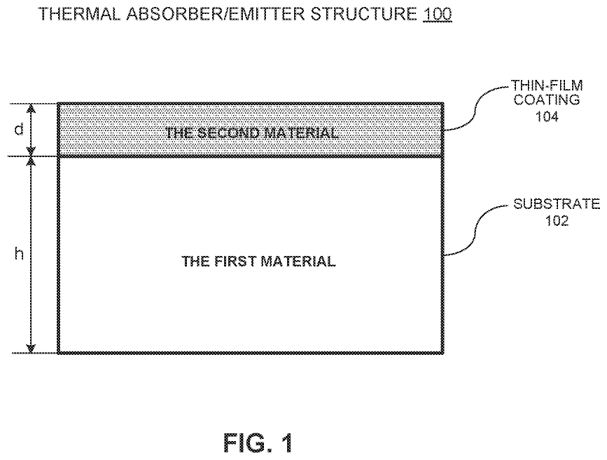

FIG. 1 shows a schematic representation 100 of a proposed thin-film-based thermal absorber/emitter structure (also referred as to as “structure 100,” “absorber/emitter 100,” and/or “absorber/emitter structure 100” hereinafter) configured with controllable emission properties at ultra-high operating temperatures, in accordance with the disclosed embodiments. As can be seen in FIG. 1, thermal absorber/emitter structure 100 is composed of a substrate 102 and a thin-film layer/coating 104 disposed on a surface of substrate 102. During operation, structure 100 can be used as an absorber to absorb energy from a heat source, such as the light radiation from the sun, which causes heat to build up and temperature to rise in absorber/emitter structure 100. Moreover, absorber/emitter structure 100 can be used as an emitter that generates a target emission spectrum when structure 100 is heated to a target operating temperature. Moreover, the thin-film layer 104 can serve two functions: (1) as a protective barrier/interface; and (2) as the primary optical layer. Note that absorber/emitter structure 100 is equivalent to placing just one additional thin-film layer or coating over a sufficiently thick substrate. Hence, the thermal absorber/emitter structure 100 is also referred to as “two-layer structure 100” and/or “two-layer absorber/emitter 100” below.

Substrate 102 has a thickness h, whereas thin-film coating 104 has a thickness d, wherein h>d. In some implementations, thickness d of the thin-film coating can have a value selected between 5 nm to 1 μm, but no thicker than 1 μm. In some illustrative configurations, thickness d of thin-film coating 104 is significantly less than 100 nm, which may be referred to as “ultra-thin film” configurations. In some implementations, thickness h of the substrate can be between a few microns and ˜1 mm, and can be fixed to a particular value in various configurations of two-layer structure 100. In contrast, thickness d of thin-film coating 104 may vary for the same application or in different applications to achieve different emission properties/profiles optimized for these applications.

Substrate 102 is made a first type of material (also referred to as the “first material” or “material X” below) whereas thin-film coating 104 is made of a second type of material (also referred to as the “second material” or “material Y” below), wherein the first material and the second material are different materials selected from a collection of candidate materials that may feature wide variety. Note that the variety of options for choosing each of the two first and second materials among the collection of candidate materials to construct absorber/emitter structure 100 provides two design parameters for the structure.

One way to tune the thermal emission properties of a heated material is to manipulate the absorption properties of the heated material, wherein the absorption properties are strongly related to the optical properties of the material. Consequently, to configure absorber/emitter 100 with desirable thermal emission properties, we can select the first and second materials from known materials that possess the desired optical properties. However, if there are no known materials with the desired optical properties, we can create new materials that have such properties.

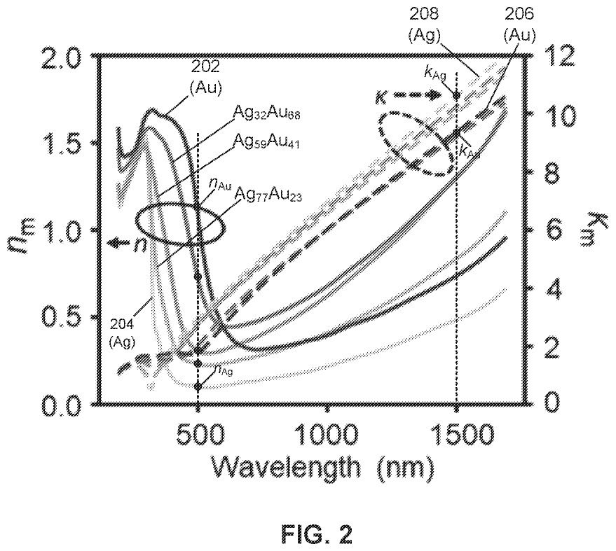

FIG. 2 shows the concept of customizing optical properties by alloying two metals Ag and Au. As can be seen in FIG. 2, without alloying, we have known refractive index vs. wavelength relationships 202 and 204 for pure Au and pure Ag, respectively. For example, at A=500 nm, Au has a significantly higher refractive index than that of Ag. However, by alloying Ag and Au based on various mixing ratios, additional refractive index values can be created between the two refractive indices corresponding to pure Ag and Au. Similarly, without alloying, we have the imaginary part of the refractive indices (which is related to optical absorption) vs. wavelength relationships 206 and 208 for pure Ag and pure Au, respectively. By alloying Ag and Au based on these same mixing ratios, additional values can be created between the imaginary parts of the refractive indices corresponding to pure Ag and Au. The examples in FIG. 2 demonstrate that, when the desired material/optical properties are not available from the currently-known materials, we can create (e.g., by alloying or by using other synthetic techniques) new materials with the desired material/optical properties from known materials with known properties. Hence, the collection of candidate materials for the first and second material should be considered to include both currently-known materials and later-developed materials.

In some embodiments, each of the first material and the second material are selected from a collection of candidate materials that have high-melting points. The target applications of the thin-film-based absorber/emitter structure are high and ultra-high temperature applications with a minimum operating temperature of T=1500° C., but often times >1700° C., and ideally exceeding 2000° C. Hence, in some embodiments, choosing the first and second materials with high melting points is a starting point for designing the disclosed thermal absorber/emitter.

In some embodiments, the collection of candidate materials is composed of materials having melting points within a temperature range of 1700° C.-2000° C. In some other embodiments, the collection of candidate materials is composed of materials having melting points within a wider temperature range, such as between 1500° C. and 2200° C.

Because absorber/emitter structure 100 is composed of two layers made of two different materials, avoiding potential thermal expansion mismatch between the two layers at high operating temperatures is one of the design objectives and one of the design criteria for the structure. In particular, from around room temperature all the way up to an ideal ultra-high operating temperature (e.g., up to 2000° C.), the selected first and second materials should have the same or similar thermal expansion coefficients. This thermal-matching condition between the selected first and the second materials makes absorber/emitter structure 100 significantly more tolerant to thermal stresses, thereby avoiding potential cracking at ultra-high operating temperatures. Compared with emitters based on multilayer structures and metamaterial structures, the disclosed single-layer/substrate structure makes it significantly easier to find thermally-matched materials to meet the thermal-matching requirement, and therefore reduces the likelihood of thermal failure.

In some embodiments, to select two materials from the collection of candidate materials that are thermally matched with each other, the thermal expansion behaviors of all materials in the collection of candidate materials are determined and compared. For example, for each material in the collection of candidate materials, we can determine a thermal expansion coefficient as a function of temperature T over a desirable temperature range, from room temperature (˜20° C.) to an ultra-high temperature (e.g., ˜2500° C.). Note that thermal expansion coefficient of a given candidate material can be computed based on the linear expansion relationship:

$$α ( T ) = Δ L / L ( \% ) ,$$

wherein ΔL is the change in length of the material as a result of a change in temperature, and L is the original length of the material. Next, a thermal mismatch at a set of temperature points can be calculated between each pair of candidate materials in the collection of candidate materials. In some embodiments, the thermal mismatch as a function of temperature T between a candidate material X and a candidate material Y, and can be expressed as:

$$Δα ( T ) = {α}_{X} ( T ) - {Δα}_{Y} ( T ) ,$$

wherein α_{X} is the thermal expansion coefficient of candidate material X, and α_{Y} is the thermal expansion coefficient of candidate material Y.

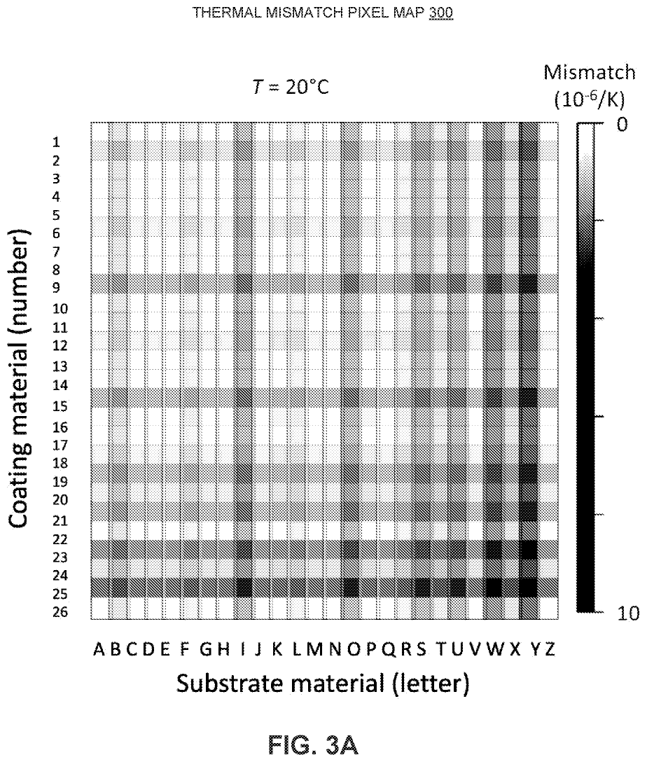

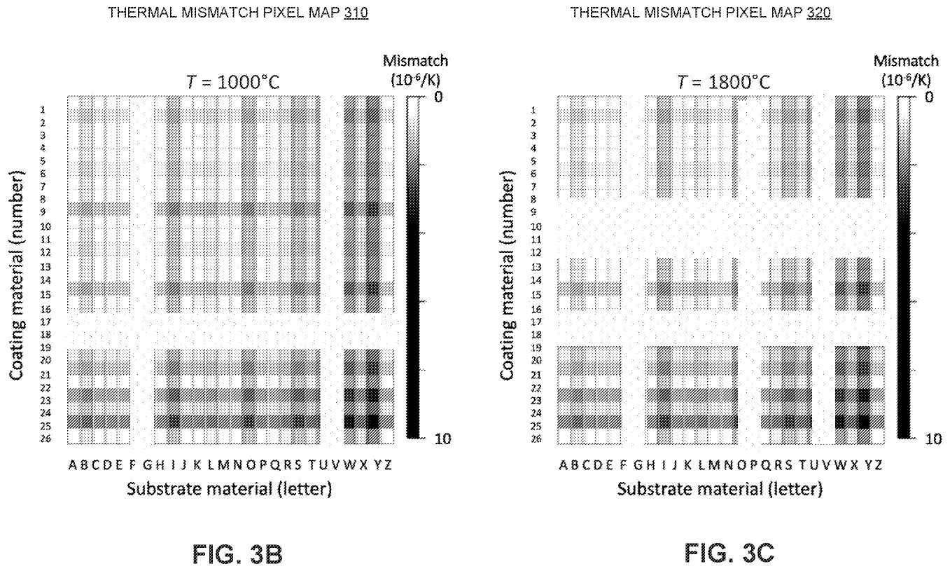

FIG. 3A shows a thermal-mismatch pixel map 300 generated for an exemplary collection of candidate materials at a room temperature T=20° C. in accordance with the disclosed embodiments. Within the thermal-mismatch pixel map 300, each pixel corresponds to a computed thermal mismatch value for a pair of candidate materials in the collection of candidate materials. More specifically, the vertical axis represents candidate materials for material Y (i.e., the coating material) using a set of numbers 1-26, whereas the horizontal axis represents candidate materials for material X (i.e., the substrate material) using a set of letters A-Z. Note that the set of numbers 1-26 in the vertical axis corresponds to a first subset of materials selected from the collection of candidate materials, whereas the set of letters A-Z in the horizontal axis corresponds to a second subset of materials selected from the collection of candidate materials, wherein the first subset of materials and the second subset of materials can be different from each other but can have overlapping materials. Moreover, the thermal mismatch value for each pixel within thermal-mismatch pixel map 300 is represented by a grayscale scheme, such that the shading levels of the pixels decrease as the corresponding thermal mismatch values decrease. Using thermal-mismatch pixel map 300, pairs of candidate materials that are thermally matched with each other at T=1000° C. can be visually identified. Note that these identified thermally-matched pairs of candidate materials represent a subset of all possible material pairs between different materials in the collection of candidate materials.

A thermal-mismatch pixel map can be generated for a plurality of temperature points within the target operating temperature ranges. For example, FIG. 3B shows another thermal-mismatch pixel map 310 generated for the exemplary collection of candidate materials at a very high temperature T=1000° C. in accordance with the disclosed embodiments. FIG. 3C shows yet another thermal-mismatch pixel map 320 generated for the exemplary collection of candidate materials at an ultra-high temperature T=1800° C. in accordance with the disclosed embodiments. Note that each thermal-mismatch pixel map 300, 310, and 320 can be used to identify pairs of candidate materials X and Y that meet the thermal-matching criterion for the absorber/emitter structure 100 at the corresponding temperature. Moreover, to identify those pairs of candidate materials X and Y that satisfy the thermal-matching criterion over the full temperature range of [20° C., 1800° C.], we can filter out those pairs of candidate materials X and Y that meet the thermal-matching criterion for all three temperature points (i.e., the intersection of three subsets of identified pairs of candidate materials that meet the thermal-matching criterion at all three temperatures T=20° C. 1000° C., and 1800° C.).

In some embodiments, in addition to selecting the first material and the second material for absorber/emitter structure 100 that have high melting points and satisfy the thermal-matching criterion, the first material and the second material are also selected based on the target emission properties/responses for specific applications, e.g., target thermal emission properties/spectra for thermophotovoltaic (TPV) applications at ultra-high operating temperatures. Note that the target emission properties/responses are generated by the two-layer structure 100 as a result of optical interference effects within the two-layer structure 100 when the first material and the second material are both lossy materials.

More specifically, these optical interference effects arise from significant optical phase accumulation caused by the phase shift that takes place at the interface between the two selected lossy materials for the two-layer structure 100 and the phase shift inside the lossy thin-film layer 104 (based on the concepts of ultra-thin film optics). Consequently, the overall optical/emission properties/responses of the two-layer structure 100 result at least in part from individual optical properties of the selected first material and the selected second material, and particularly the refractive indices (nₖ₁ and nₖ₂) of the two materials. Additional contributions to the overall optical/emission properties/responses of the two-layer structure 100 include: (1) the choices of different thicknesses for the thin-film layer 104; (2) the choices of different thicknesses for substrate 102 (which generally play a less significant role in affecting the optical/emission properties than the thickness of thin-film layer 104); and (3) the operating temperatures.

Note that even though thermal absorber/emitter structure 100 has a simple two-layer (i.e., single-coating/substrate) structure, the proposed structure 100 still provides a rich set of controllable parameters and therefore a high degree of design flexibility for implementing desired/target emission properties (e.g., emission spectrum) in the overall absorber/emitter structure 100. These controllable parameters include at least the following four parameters:
Different choices of the first material for the substrate which give rise to different optical properties of the substrate;
The thickness of the substrate;
Different choices of the second material for the thin-film layer/coating which give rise to different optical properties of the thin-film layer/coating; and
The thickness of the thin-film layer/coating.

Moreover, within each of the two material selection parameters, there are also a multitude of choices for each material in terms of: (1) pure metals vs. alloys; (2) the number of elements in a given material (e.g., 1, 2, 3, 4, etc.); and (3) existing materials vs. new materials having the desirable optical (e.g., emission) properties, among others. Note that once the target optical properties are specified, new materials can be developed for both the substrate and thin-film coating to achieve the target optical properties.

However, once the configuration of absorber/emitter structure 100 is fixed, the simple two-layer structure makes fabrication and/or manufacturing of the proposed thermal absorber/emitter structure 100 for various thermal emission applications extremely straightforward, low-cost, and scalable, without the complexity, time and monetary costs associated with nanofabrication processes to create metamaterials/nanostructures or multilayer structures.

It should be noted that even when the selected first material and second material are different materials, they should have different optical properties, e.g., different refractive indices to effectuate optical interference effects within two-layer structure 100. In other words, the first and second materials should have different optical properties in addition to being different materials. In some embodiments, acquiring desirable optical/emission properties of absorber/emitter structure 100 can be facilitated by choosing the first and second materials that have greater differences in their optical properties, e.g., a greater difference in their refractive indices. Note that an additional benefit of using different materials for substrate 102 and thin-film coating 104 is prevention of the two layers of structure 100 from fusing together to form a monolithic structure without a structural interface.

The first material for substrate 102 and/or the second material for thin-film coating 104 can be composed of any number of elements (i.e., one or more). For example, each of the first material and the second material can be a type of ternary alloy carbide or a type of quaternary alloy carbide. In some embodiments, the first material for substrate 102 is a single element (pure) metal selected from the following group of refractory metals: Cr, Hf, Ir, Mn, Mo, Nb, Os, Re, Ru, Ta, Ti, and W; whereas the second material for thin-film coating 104 is a metal nitride having a metal selected from that following group: Al, B. Sc, Hf, Nb, Ti, V, and Zr. As a result, two-layer structure 100 has a metal-nitride/refractory-metal structure. For example, two-layer structure 100 can be one of the following metal-nitride/refractory-metal structures: TiN/Cr, TiN/Hf, TiN/Mo, TiN/Ti, TiN/W. However, in the above listed metal-nitride/refractory-metal structures, Ti in the metal nitride can be replaced with another metal selected from Al, B, Sc, Hf, Nb, V, and Zr.

In some embodiments, to use an alloy of refractory metals as the first material for substrate 102, the effects of alloying on the permittivity (E) of refractory metals (e.g., Cr, Mo, Ta, W, etc.) were investigated. In some embodiments, thermochemically and thermodynamically stable quaternary metal nitrides were developed for thin-film coating 104, wherein these quaternary metal nitrides are the combinations of metal nitrides using metal elements from groups II through V (e.g., Ti, Ta, Zr, Hf, Mg, Ca, Sc, Y, and Al) of the periodic table and metal oxides using metal elements from groups IIIb and IVb of the periodic table. Note that creating new quaternary materials based on metal nitrides of group II through V metal elements and transition metal oxides/carbides (e.g., Hf—Ta—O, or Ta—Hf—C) allows for fine tuning the optical properties of two-layer structure 100 using different combinations of the above chemical compositions.

In some embodiments, one or both of the first material for substrate 102 and the second material for thin-film coating 104 comprise a carbide that includes one or more elements selected from the following group: B. C. Si, Nb, Hf, Ta, Ti, V, W, and Zr. In some embodiments, one or both materials comprise a metal nitride that includes a metal element selected from the following group: Al, B, Sc, Hf, Nb, Ti, V, and Zr. In some embodiments, one or both materials comprise a metal oxide that includes a metal element selected from the following group: MgAl, Al, Be, Ca, Cr, Mg, Sc, Dy, Gd, Hf, La, Lu, Nb, Sc, Ta, Ti, Y, and Zr. In some embodiments, one or both materials comprise a metal silicide that includes a metal element selected from the following group: Mo, Ta, and W. In some embodiments, one or both materials comprise a metal boride that includes a metal element selected from the following group: Hf, Nb, Ta. Ti, and Zr.

In some embodiments, one or more materials are selected from the following group of silicon ceramics: SiC, Si₃N₄, fused SiO₂, and crystalline SiO₂. In some embodiments, the first material and/or the second material is glassy carbon or carbon diamond.

Note that once the first and second materials are selected and thicknesses for the selected materials are set for the two-layer structure 100, the emission spectrum of this two-layer structure configuration at a given operating temperature can be determined. However, directly measuring the emission spectrum for ultra-high temperature applications requires heating up the two-layer structure to that operating temperature, which can be a cumbersome and labor-intensive endeavor. As one alternative to directly measuring the emission spectrum, the absorption spectrum of the same two-layer structure can be measured. This is because, according to Kirchhoff's law, there is reciprocity between the emission property and the absorption property of a given material (either a single-element or a multi-element material). This means that there is an equivalency between the absorptivity and the emissivity of a given material, wherein both the absorptivity and the emissivity are functions of wavelength. More specifically, if a material can absorb a certain wavelength of radiation, it will also emit radiation at that certain wavelength when the material is heated up. On the other hand, if a material does not absorb a certain wavelength of radiation, it will not emit radiation at that certain wavelength when the material is heated up. Hence, the overall absorption spectrum of a given material will have the identical spectral shape to the emission spectrum for the given material weighted by the Planck blackbody spectrum.

Based on the theory of reciprocity, we can first measure the absorption spectrum of each configuration of two-layer structure 100 when the materials and thicknesses are selected. The measured absorption spectrum can then be directly compared with the target emission spectrum by comparing their peak absorption/emission wavelengths and spectral shapes. In contrast to directly measuring the emission spectrum at an ultra-high operating temperature, the absorption spectrum can be measured at a relatively lower temperature, thereby avoiding heating up structure 100 to the ultra-high operating temperature. When the configuration of two-layer structure 100 is changed, e.g., as a result of changing one or both materials or the thickness of the thin-film coating, the emission spectrum of the structure is also changed. The new emission spectrum corresponding to the new configuration of the structure can be determined by measuring the absorption spectrum of the new configuration. Hence, a proper configuration of the two-layer structure 100 having the target emission spectrum can be determined by continuously modifying the controllable parameters to continuously modify the corresponding absorption spectrum, until the tailored absorption spectrum matches the target emission spectrum.

In some embodiments, instead of directly measuring either the emission or the absorption spectrum of each configuration of two-layer structure 100, either the absorption spectrum or the emission spectrum of a given configuration of two-layer structure 100 can be determined by performing a simulation. For example, the inputs to an absorption model for two-layer structure 100 can include the refractive indices (nₖ₁ and nₖ₂) of the selected first and second materials for the two layers of two-layer structure 100 and the chosen thicknesses (d and h) for the two layers. Note that it may be easier to simulate the absorption spectrum than to simulate the emission spectrum because the amount of absorption of a material at a given wavelength can be more directly correlated to the refractive index of the material. Hence, even when simulation is used to determine the emission spectrum, we can first simulate the absorption spectrum, and then determine the emission spectrum based on the theory of reciprocity.

In some embodiments, a hybrid simulation-measurement approach can be used to design two-layer structure 100 to achieve the target emission spectrum. Specifically, a simulation process can be initially used on various configurations of two-layer structure 100 by changing the material selections and/or changing the thickness of the thin-film coating of the structure. Moreover, the simulation process can be combined with a type of optimization process, such as an iterative method (e.g., a stochastic approximation) to arrive at an optimized configuration for two-layer structure 100 that is sufficiently close to the target emission spectrum. Next, either the absorption spectrum or the emission spectrum of the optimized configuration can be measured. The measured spectrum or the difference between the measured spectrum and the simulated spectrum can be used as a feedback input to the simulation/optimization model to adjust the design parameters, such as the thickness of the thin-film coating. Note that this hybrid design approach can be most useful for creating new material designs for two-layer structure 100 that are not yet available in the collection of candidate materials, or for materials that are brand new.

The absorption/emission spectrum of two-layer structure 100 is primarily determined by the optical properties of the two selected materials and the optical interference conditions. This means that, after the two materials have been selected, the absorption/emission spectrum of the two-layer structure based on the two selected materials can be further adjusted/tuned by varying the thickness d of the thin-film coating 104 to effectuate changes in the optical interference conditions within structure 100. Hence, to design an optical absorber/emitter using the proposed two-layer structure, the target emission properties can be achieved by controlling at least three design variable/parameters: (1) the optical properties of the selected first material for the substrate 102; (2) the optical properties of the selected second material for the thin-film coating 104; and (3) the thickness of the thin-film coating 104. In some embodiments, to obtain the target emission spectrum based on the proposed two-layer structure 100, the thickness of substrate 104 can be used as another control variable to fine-tune the overall absorption/emission spectrum of the structure.

If the absorption/optical properties of the two-layer structure 100 based on the selected first and second materials do not change significantly when varying the thickness of thin-film coating 104, this may indicate that the selected second material for the thin-film coating is a poor choice for the substrate based on the selected first material. Under such circumstances, we can choose a different second material from the collection of candidate materials for the coating, and subsequently repeat the absorption properties tuning process by varying the thickness of the coating in order to achieve the target properties.

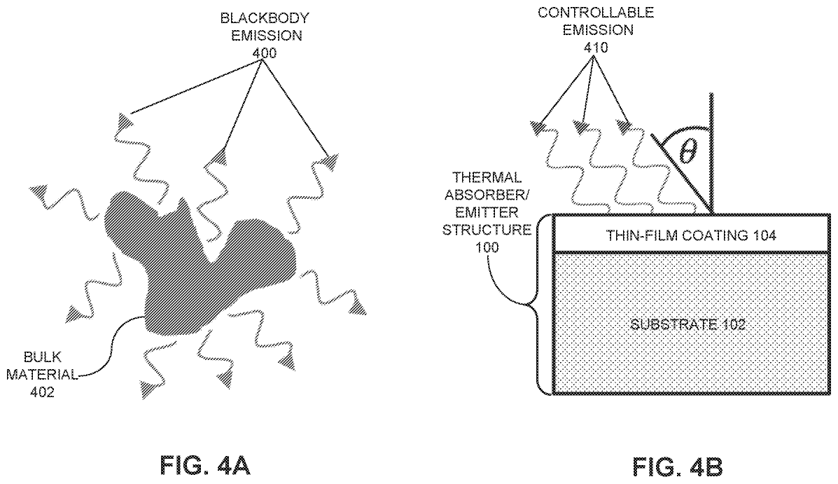

FIGS. 4A and 4B illustrate the contrast between the ideal blackbody emission and controllable emission profiles generate by a two-layer absorber/emitter structure described herein. Specifically, FIG. 4A shows the isotropic blackbody emission 400 generated by a bulk material 402. As can be seen, bulk material 402 behaves like a diffuse/blackbody emitter, such that it radiates energy isotropically, wherein the intensity of the emitted energy is independent of the direction. In contrast, FIG. 4B shows the controllable emission 410 of the two-layer thermal absorber/emitter structure 100 in accordance with the disclosed embodiments. As illustrated in FIG. 4B, absorber/emitter structure 100 can be configured and fine-tuned to radiate energy anisotropically such that the intensity of the emitted radiation is directional. For example, absorber/emitter structure 100 can be configured and fine-tuned to emit radiation in a specific radiation angle θ. In some embodiments, the direction of radiation of absorber/emitter structure 100 can be controlled by selecting two materials that have significantly different optical properties (e.g., with high difference between nₖ₁ and nₖ₂) for the substrate and the thin-film coating, and then varying the thickness of the thin-film coating to effectuate a particular manner of optical interference between the two material layers that gives rise to an anisotropic emission in a desirable radiation direction/angle.

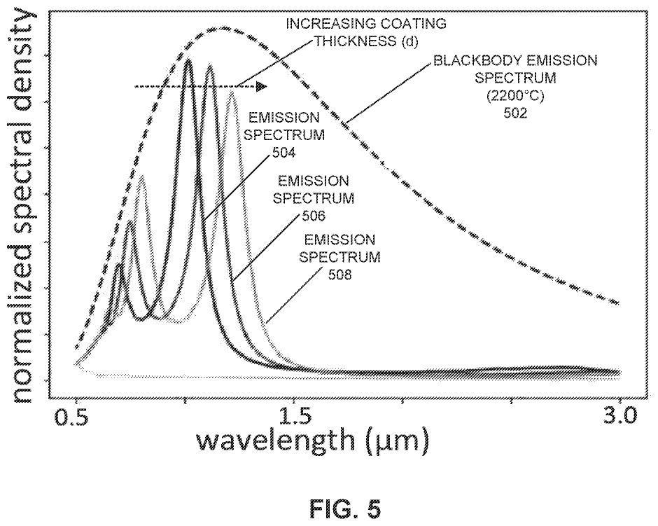

FIG. 5 shows a comparison of an ideal blackbody emission spectrum 502 at 2200° C. and tunable emission spectra generate by the absorber/emitter structure 100 in accordance with the disclosed embodiments. Blackbody emission spectrum 502 (the dashed curve) in FIG. 5 shows that a blackbody absorbs radiation over nearly all wavelength ranges and also re-radiates over nearly all wavelength ranges. In contrast, FIG. 5 also shows a group of tunable emission spectra 504-508 (the solid curves) generated by the absorber/emitter structure 100, which correspond to different thicknesses of the thin-film layer 104. Specifically, as the thickness of the thin-film layer increases (e.g., from 150 nm to 200 nm), we obtain the group of emission spectra 504-508 with the peak emission wavelength shifting toward a longer wavelength.

Note that the tunable emission spectra 504-508 differ from the blackbody emission spectrum 502 in at least two aspects. Firstly, all tunable emission spectra of absorber/emitter structure 100 can be tailored/shaped to suppress radiation above the target radiation wavelengths (e.g., λ>1.5 μm) to near zero. In other words, each tunable emission spectrum in the set of tunable emission spectra 504-508 has a narrow bandwidth emission profile. As a result, the waste heat generated by absorber/emitter structure 100 can be significantly reduced at the operating temperature while the useful energy can be concentrated around a target radiation wavelength. Secondly, by controlling the thickness of the thin-film coating 104 within absorber/emitter structure 100, the peak emission wavelength of the emission spectrum of the structure can be controlled/tuned over a range of wavelengths. In the exemplary tunable emission spectra 504-508, the peak radiation wavelength of the structure can be tuned between 2=0.5 μm and λ=1.5 μm, with a peak radiation obtained at ˜1.0 μm.

Controlling the profile (including the peak absorption/emission wavelength) of the absorption/emission spectrum of absorber/emitter structure 100 may begin with choosing the second material for the thin-film coating to have a desirable refractive index nₖ₀. Generally speaking, a longer peak absorption/emission wavelength of structure 100 can be obtained by selecting a second material having a relatively low refractive index for a given film thickness. In contrast, a shorter peak absorption/emission wavelength of structure 100 can be obtained by selecting a second material having a relatively high refractive index for the same given film thickness.

Note that if there is no available material in the collection of candidate materials that possesses the desirable refractive index nₖ₀, we can identify two materials in the collection of candidate materials that have known refractive indices nₖ₁ and nₖ₂, such that nₖ₁<nₖ₀<nₖ₂. Next, we can create a new material that has the desirable refractive index nₖ₀ by mixing, synthesizing, or alloying the two materials with the known refractive indices nₖ₁ and nₖ₂. The new material can then be used as the second material for the thin-film coating to achieve the target emission spectrum. In some embodiments, a desirable emission spectrum of absorber/emitter structure 100 can be obtained by first selecting the second material with the desirable refractive index no for the thin-film coating, and subsequently fine-tuning the overall absorption/emission spectrum of structure 100 by varying the thickness of the thin-film coating.

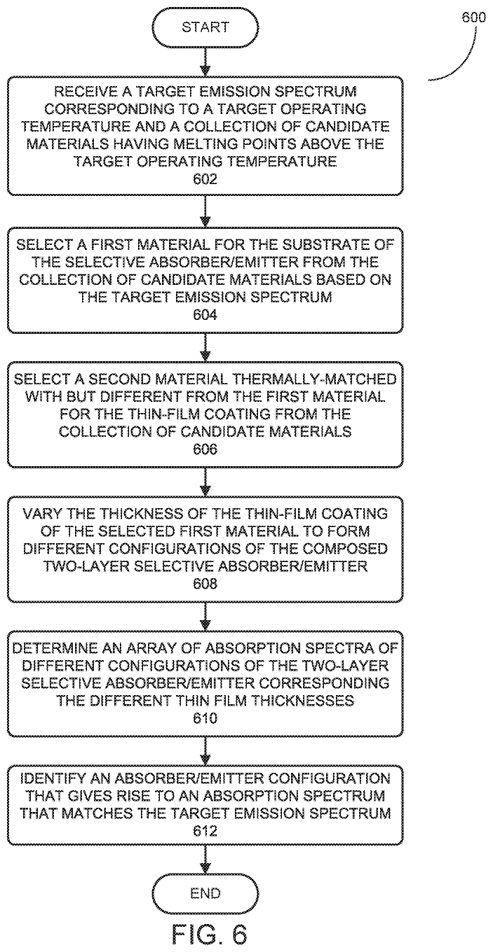

FIG. 6 presents a flowchart illustrating a process 600 of designing a selective absorber/emitter having a tunable emission profile based on two-layer absorber/emitter structure 100 in accordance with the disclosed embodiments. Process 600 begins with receipt of a target emission spectrum corresponding to a target operating temperature (e.g., an ultra-high temperature at 2000° C.) and a collection of candidate materials having melting points above the target operating temperature (step 602). The specific target emission spectrum may be determined based on the target application(s), such as a thermophotovoltaic (TPV) application or a heat shield application. In some embodiments, the target emission spectrum can have a predetermined peak wavelength at the target operating temperature.

Next, a first material and a proper thickness for the substrate of the selective absorber/emitter are selected from the collection of candidate materials based on the target emission spectrum and the target operating temperature (step 604). For example, the selected substrate material can have an absorption spectrum that has a peak absorption wavelength sufficiently close to the peak emission wavelength of the target emission spectrum. In some embodiments, the first material is chosen from a group of refractory metals.

Next, a second material different from the first material is selected for the thin-film layer/coating of the selective absorber/emitter, from the collection of candidate materials, wherein the second material is thermally matched with the first material and has desirable optical properties (step 606). In some embodiments, the second material is chosen from a group of metallic oxides, a group of metallic nitrides, a group of metallic carbides, a group of metallic silicides, or a group of metallic borides.

Next, the thickness of the thin-film coating made of the selected first material is varied to form different configurations of the composed two-layer selective absorber/emitter (step 608). For example, process 600 can start from a lower bound of the coating thickness, e.g., ˜5 nm, and gradually increase the thickness toward an upper bound, e.g., ˜200 nm, using an increment of 1 nm to 5 nm. At each different thickness of the thin-film coating, an absorption spectrum for the new configuration of the absorber/emitter is determined as a result of the optical interference between the two material layers (step 610).

After an array of absorption spectra corresponding to the array of coating thicknesses has been determined, the spectra can be compared against the target emission spectrum to identify an absorption spectrum that matches the target emission spectrum, thereby identifying the corresponding thin-film coating thickness and selective absorber/emitter configuration (step 612). Note that the absorption spectra can be directly compared against the target emission spectrum because of the reciprocity between the absorption spectrum and the corresponding emission spectrum.

In some embodiments, process 600 can facilitate the above comparisons by aggregating the array of absorption spectra onto an absorption vs. wavelength plot. One of the tunable properties of the absorption spectrum is the peak absorption (and hence emission) wavelength. In some embodiments, to tune the peak absorption/emission wavelength toward a longer target wavelength, the thickness of the thin-film coating in the two-layer selective absorber/emitter can be increased. In contrast, to tune the peak absorption/emission wavelength toward a shorter target wavelength, the thickness can be decreased. Because the substrate is generally much thicker than the thin film coating, the thickness of the substrate can be considered infinite, and as such is not considered as a design variable.

### Use Case—Ultra-High Temperature Thermophotovoltaic Systems

As a specific application of high-temperature thin-film-based absorber/emitter structure 100 of FIG. 1, a high-temperature emitter with selective emission for use in a silicon (Si) solar cell thermophotovoltaic (TPV) system is developed. The specific example of Si TPV is chosen to verify the concepts of structure 100 because silicon's bandgap energy necessitates ultra-high temperatures that are well beyond what is typically achievable with other TPV systems. Even though Si is the main commercial PV material currently deployed, Si TPV is not currently feasible as a commercial option due to the ultra-high temperature requirements and the need for selective emission. However, because of Si's widespread use, significant advancements in the Si-TPV technology can have important commercial applications.

There are a number of challenges in designing high-efficiency thermal emitters for Si TPV applications. First, the emitter materials have to be stable at ultra-high temperatures (e.g., with ideal temperature >2000° C.). Second, it is a design objective to make nearly all of the thermal emission to occur near the bandgap energy of the semiconductor material used for the PV cell in the TPV system. This is because longer wavelengths are not absorbed by the semiconductor PV cell and therefore are lost as heat (unless reflected back to the emitter). Similarly, emitted photons that are significantly above the bandgap energy of the semiconductor material are absorbed but produce an energy loss due to carrier thermalization, thus reducing its power conversion efficiency.

Third, modeling and fabrication of tailored emitters are generally difficult because little data is available for the optical properties of thermal emitters at extreme temperatures. As a result, low temperature values of the optical property were generally assumed for modeling thermal emitters. Fourth, some state-of-the-art TPV emitters use refractory metals or binary nitrides and nanofabrication to create photonic structures. However, while the refractory materials are generally stable at high temperatures, the nanostructures fabricated to operate at room temperature are generally not stable at high temperatures, and the maximum stable temperature is usually <1500° C., well below the ideal temperature for maximum TPV efficiency. Although it has been suggested that Si TPV could reach >20% efficiency with Mo nanostructures, the fabrication process, the scalability, and the stability of such nanostructures are unproven. Unsurprisingly, even though the current state-of-the-art Si TPV based on engineered optical structures has a maximum theoretical efficiency of 6.4%, experimental data only showed an efficiency of ˜1.18%.

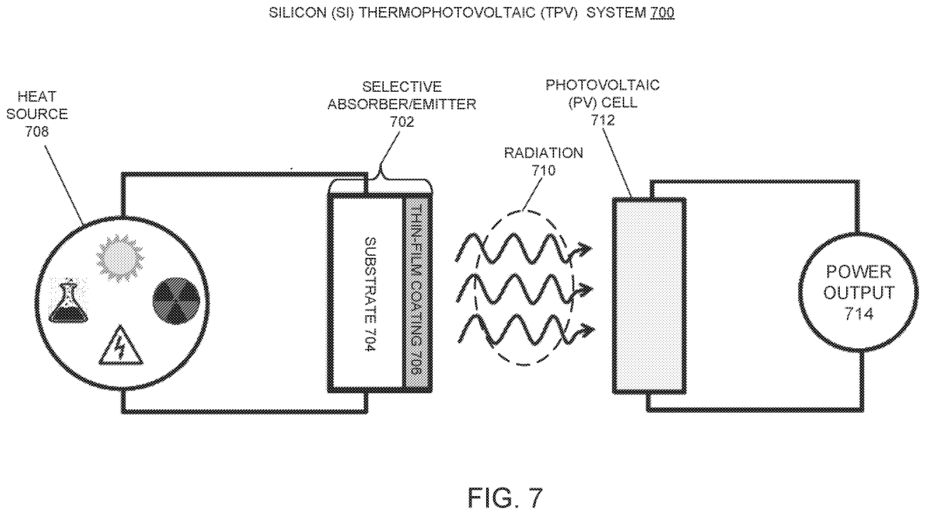

FIG. 7 illustrates an exemplary Si TPV system 700 using the disclosed two-layer structure as the selective emitter in accordance with the disclosed embodiments. As illustrated in FIG. 7, TPV system 700 includes a selective absorber/emitter 702 made of a particular material and thickness configuration of the disclosed high-temperature thin-film-based absorber/emitter structure, and a photovoltaic (PV) cell 704 made of Si and one or more optional coatings.

As can be seen in FIG. 7, selective absorber/emitter 702 has a two-layer structure including a substrate 704 made of the selected first material of a first selected thickness and a thin-film coating 706 made of the selected second material and having a second selected thickness. During operation, selective absorber/emitter 702 is used to absorb heat (e.g., solar heat) from a heat source 708 (e.g., the sun) from the substrate 704 side of the two-layer structure. The accumulated heat causes the temperature of selective absorber/emitter 702 to rise and reach a target ultra-high operating temperature so that the selective absorber/emitter emits photon radiation 710 with a designed (i.e., selective) emission spectrum and a designed emission angle from the thin-film coating 706 side of the two-layer structure toward PV cell 712. PV cell 712 then converts the received photon radiation 710 into an electrical power output 714 of Si TPV system 700.

Silicon TPV system 700 overcomes all the previously described challenges associated with designing high-efficiency Si TPV systems because: (1) the selected materials for the emitter 702 are stable (both having ultra-high melting points and being thermally matched) at ultra-high temperatures; (2) the actual optical and thermal properties of the emitter materials at target ultra-high temperatures are used as inputs to the emission models; and (3) a single thin-film coating is used to tailor the emission spectrum, which allows for significantly more robust stability and manufacturing.

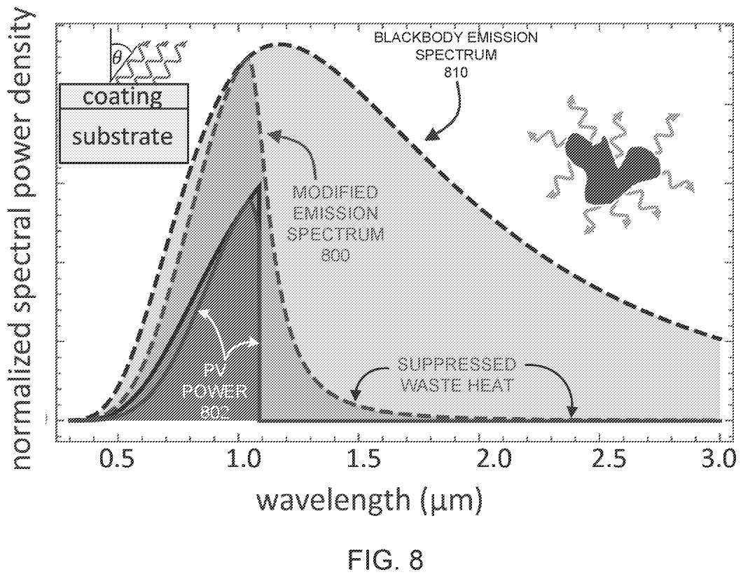

As described above, the emission spectrum of selective absorber/emitter 702 of Si TPV system 700 can be tailored, shaped, or modified simply by altering thin-film coating 706 of selective absorber/emitter 702 to achieve the target emission properties. FIG. 8 shows an exemplary modified emission spectrum 800 of the exemplary Si TPV system 700 resulting from tuning the thin-film coating 706, and the corresponding PV output power profile 702 in accordance with the disclosed embodiments. As can be seen in FIG. 8, the modified emission spectrum 800 is configured to significantly suppress radiation/thermal losses at longer wavelengths above a target radiation wavelength λ=˜1.1 μm (which is determined by the silicon bandgap) to achieve a tailored narrowband emission spectrum at the band edge of Si. This is in clear contrast to the broadband blackbody emission spectrum 810, which is also shown in FIG. 8. Note that the modified emission spectrum 800 has an asymmetric Lorentzian profile. Moreover, the exemplary Si TPV system 700 maintains a high electrical power output 702 in the vicinity of the target radiation wavelength.

To determine the effectiveness of selective absorber/emitter 702 of FIG. 7, we can define the figure of merit (FOM) as the power conversion efficiency computed as the usable electrical power divided by the total power generated from the emitter. By reducing emissions from wavelengths that are not used by the PV cell 712, the power lost due to the waste heat is greatly suppressed, which results in significantly increased FOM. As an example, we simulated the operation of the selective absorber/emitter 702 at 2200° C. with a suppression of long wavelength (i.e., those wavelengths longer than the wavelength associated with the Si bandgap of ˜1.1 μm) emission by 80%, and found a predicted heat-to-electricity efficiency increase of 27%. This represented a greater than 4× (>400%) increase in conversion efficiency over the current theoretical maximum of 6.4% of the existing state-of-the-art Si TPV designs.

Although we have described applications of the disclosed thin-film-based thermal absorbers/emitters in terms of Si TPV systems, the general principles of designing and constructing Si TPV systems using the disclosed two-layer absorber/emitter structures can be equally applied to other TPV systems and other applications that require thermal emission control.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A thermal absorber/emitter, comprising:
a substrate layer; and
a thin-film layer disposed over the substrate layer for controlling and tuning emission properties of thermal radiation emitted from the thermal absorber/emitter at an operating temperature exceeding 1500° C.

2. The thermal absorber/emitter of claim 1, wherein the emission properties of the thermal radiation include an emission spectrum, and wherein the emission spectrum of the thermal absorber/emitter is tunable by varying the thickness of the thin-film layer.

3. The thermal absorber/emitter of claim 1, wherein the tunable emission properties include one or more of:
a peak emission wavelength of the thermal radiation;
a bandwidth of the thermal radiation; and
an emission angle of the thermal radiation.

4. The thermal absorber/emitter of claim 1, wherein the thermal absorber/emitter operates in an environment featuring a temperature greater than 1500° C.

5. The thermal absorber/emitter of claim 1, wherein the thin-film layer comprises a single layer no thicker than 1 μm.

6. The thermal absorber/emitter of claim 1, wherein the substrate layer has a minimum thickness of 1 μm.

7. The thermal absorber/emitter of claim 1, wherein the substrate layer is made of a first material, the thin-film layer is made of a second material, and wherein the first material and the second material are different materials.

8. The thermal absorber/emitter of claim 7, wherein the emission properties of the thermal absorber/emitter are tunable by selecting the second material from a plurality of materials having different optical properties.

9. The thermal absorber/emitter of claim 7, wherein the first material and the second material have different optical properties.

10. The thermal absorber/emitter of claim 7, wherein the first material and the second material are high melt-point materials for operating temperatures exceeding 1500° C.

11. The thermal absorber/emitter of claim 7, wherein the first material and the second material are thermally matched materials at operating temperatures exceeding 1500° C.

12. The thermal absorber/emitter of claim 7, wherein the second material is selected so that the thin-film layer functions as a protective barrier for the thermal absorber/emitter.

13. The thermal absorber/emitter of claim 7, wherein at least one of the first material and the second material comprises one or more of the flowing refractory metals:
Cr, Hf, Ir, Mo, Nb, Os, Re, Ru, Ta, Ti, and W.

14. The thermal absorber/emitter of claim 7, wherein at least one of the first material and the second material comprises a carbide that includes one or more elements selected from the following group of elements:
B, C, Si, Nb, Hf, Ta, Ti, V, W, and Zr.

15. The thermal absorber/emitter of claim 7, wherein at least one of the first material and the second material comprises a metal nitride that includes a metal element selected from the following group of elements:
Al, B, Sc, Hf, Nb, Ti, V, and Zr.

16. The thermal absorber/emitter of claim 7, wherein at least one of the first material and the second material comprises a metal oxide that includes a metal element selected from the following group of elements:
MgAl, Al, Be, Ca, Cr, Mg, Sc, Dy, Gd, Hf, La, Lu, Nb, Sc, Ta, Ti, Y, and Zr.

17. The thermal absorber/emitter of claim 7, wherein at least one of the first material and the second material comprises a silicide that includes a metal element selected from the following group of elements:
Mo, Ta, and W.

18. The thermal absorber/emitter of claim 7, wherein at least one of the first material and the second material comprises a boride that includes a metal element selected from the following group of elements:
Hf, Nb, Ta, Ti, and Zr.

19. A silicon (Si) thermophotovoltaic (TPV) system, comprising:
a selective absorber/emitter; and
a photovoltaic (PV) cell made of Si,
wherein the selective absorber/emitter further comprises a two-layer structure that includes:
a substrate layer; and
a thin-film layer disposed over the substrate layer for controlling and tuning emission properties of thermal radiation emitted from the selective absorber/emitter at a target operating of the Si TPV system.

20. The Si TPV system of claim 19, wherein the emission properties of the thermal radiation include an emission spectrum, and wherein the emission spectrum of the selective absorber/emitter is tunable by varying the thickness of the thin-film layer.

21. The Si TPV system of claim 19, wherein the tunable emission properties include one or more of:
a peak emission wavelength of the thermal radiation;
a bandwidth of the thermal radiation; and
an emission angle of the thermal radiation.

22. The Si TPV system of claim 19, wherein the substrate layer of the selective absorber/emitter is made of a first material, the thin-film layer of the selective absorber/emitter is made of a second material, and wherein the first material and the second material are different materials.

23. The Si TPV system of claim 22, wherein the emission properties of the selective absorber/emitter are tunable by selecting from a plurality of materials having different optical properties as the second material for the thin-film layer.

24. The Si TPV system of claim 22, wherein the first material and the second material have different optical properties.

25. The Si TPV system of claim 22, wherein the first material and the second material are high melt-point materials for operating temperatures exceeding 1500° C.

26. The Si TPV system of claim 22, wherein the first material and the second material are thermally matched materials at operating temperatures exceeding 1500° C.

27. The Si TPV system of claim 22, wherein the second material is selected so that the thin-film layer functions as a protective barrier for the selective absorber/emitter.

28. A method of designing a selective absorber/emitter, comprising:
receiving a target emission spectrum corresponding to a target operating temperature;
selecting a first material for forming a substrate of the selective absorber/emitter based on the target operating temperature;
selecting a second material for forming a thin-film coating on the substrate to form the selective absorber/emitter; and
tuning a property of the thin-film coating to obtain a configuration of the selective absorber/emitter that gives rise to the target emission spectrum.

29. The method of claim 28, wherein selecting the second material includes selecting a material that is thermally matched with the first material at the target operating temperature.

30. The method of claim 28, wherein tuning the property of the thin-film coating to obtain the configuration includes:
varying a thickness of the thin-film coating to obtain a plurality of configurations of the selective absorber/emitter;
determining a plurality of emission spectra corresponding to the plurality of configurations of the selective absorber/emitter at the target operating temperature;
identifying in the plurality of emission spectra, a first emission spectrum that matches the target emission spectrum; and
fixing the configuration of the selective absorber/emitter using the thickness of the thin-film coating corresponding to the first emission spectrum.

31. The method of claim 28, wherein determining a given emission spectrum in the plurality of emission spectra corresponding to a given configuration in the plurality of configurations includes:
determining an absorption spectrum corresponding to the given configuration at the target operating temperature; and
determining the given emission spectrum from the determined absorption spectrum based on the principle of reciprocity.

32. The method of claim 30, wherein tuning a property of the thin-film coating to obtain the configuration of the selective absorber/emitter further includes tuning the thickness of the thin-film coating to effectuate a shift of a peak emission wavelength of the selective absorber/emitter toward the peak emission wavelength of the target emission spectrum.
